(19) United States
(12) Patent Application Publication
(10) Pub. No.: US 2016/0067709 A1
(43) Pub. Date: Mar. 10, 2016

(54) MICRO-CHANNEL MODULE

(71) Applicant: HTC Corporation, Taoyuan County (TW)

(72) Inventors: Pin-Chung Sun, Taoyuan County (TW); Sheng-Chieh Lin, Taoyuan County (TW); Yao-Ting Tseng, Taoyuan County (TW); Chung-Ju Wu, Taoyuan County (TW); Chien-Lung Huang, Taoyuan County (TW)

(21) Appl. No.: 14/477,869

(22) Filed: Sep. 5, 2014

(51) Int. Cl. B01L 3/00

(52) U.S. Cl. CPC B01L 3/502753; B01L 3/502707; B01L 3/502715; B01L 2300/0816; B01L 2300/0864; B01L 2300/0887; B01L 2200/028; B01L 2200/0647; B01L 2300/0636

(57) ABSTRACT

A micro-channel module including a lower plate, an upper plate and a double-side tape is provided. The upper plate is disposed on the lower plate. The double-side tape is disposed between the upper plate and the lower plate, so as to fix the upper plate and the lower plate, wherein the double-side tape has a plurality of micro-channel patterns, so as to define a plurality of micro-channels between the upper plate and the lower plate, and a liquid is adapted to flow in the micro-channels.

### FIELD OF THE INVENTION

The present application relates to a micro-channel module. More particularly, the present application relates to a laminate-type micro-channel module.

### DESCRIPTION OF RELATED ART

In recent years, miniaturized biochemical analysis systems have been developed. Many miniaturized inspection devices have also been applied in various kinds of inspection systems. Advantages of miniaturizing biochemical analysis systems include fast analyses, accurate quantification, low amount requirement of test specimen and space, and the like. Therefore, many inspection devices have been developed to become miniaturized.

Currently, in a biochemical analysis system, after a small amount of liquid specimen passes through a micro-channel structure for separating partial ingredients thereof, the liquid flows through a biochip, such that a biological property thereof is inspected. For the system, how to increase efficiency of fabricating a micro-channel structure or decrease difficulty of fabricating a micro-channel structure has become a focus in the art.

### SUMMARY OF THE INVENTION

The present application provides a micro-channel module, which has a simplified fabrication method, and fabricating costs thereof may be reduced.

A micro-channel module of the present application includes a lower plate, an upper plate and a double-side tape. The upper plate is disposed on the lower plate. The double-side tape is disposed between the upper plate and the lower plate, so as to fix the upper plate and the lower plate, wherein the double-side tape has a plurality of micro-channel patterns, so as to define a plurality of micro-channels between the upper plate and the lower plate, and a liquid is adapted to flow in the micro-channels.

In view of the above, in the micro-channel module of the present application, the upper plate and the lower plate are directly laminated and fixed by the double-side tape, and the plurality of micro-channels are defined between the upper plate and the lower plate through the micro-channel patterns on the double-side tape, such that the liquid may flow in the micro-channels between the upper plate and the lower plate. The micro-channel patterns on the double-side tape may be formed by using a punching method. Accordingly, the micro-channel module of the present application has a simplified fabrication method, and fabricating costs thereof may be reduced.

Several exemplary embodiments accompanied with figures are described in detail below to further describe the present application in details.

### BRIEF DESCRIPTION OF THE DRAWINGS

FIG. 1 is a schematic view illustrating a micro-channel module according to an embodiment of the present invention.

FIG. 2 is a schematic cross-sectional view illustrating the micro-channel module of FIG. 1 along line A-A′.

FIG. 3 is a schematic cross-sectional view illustrating the micro-channel module of FIG. 1 along line B-B′.

### DETAILED DESCRIPTION OF DISCLOSED EMBODIMENTS

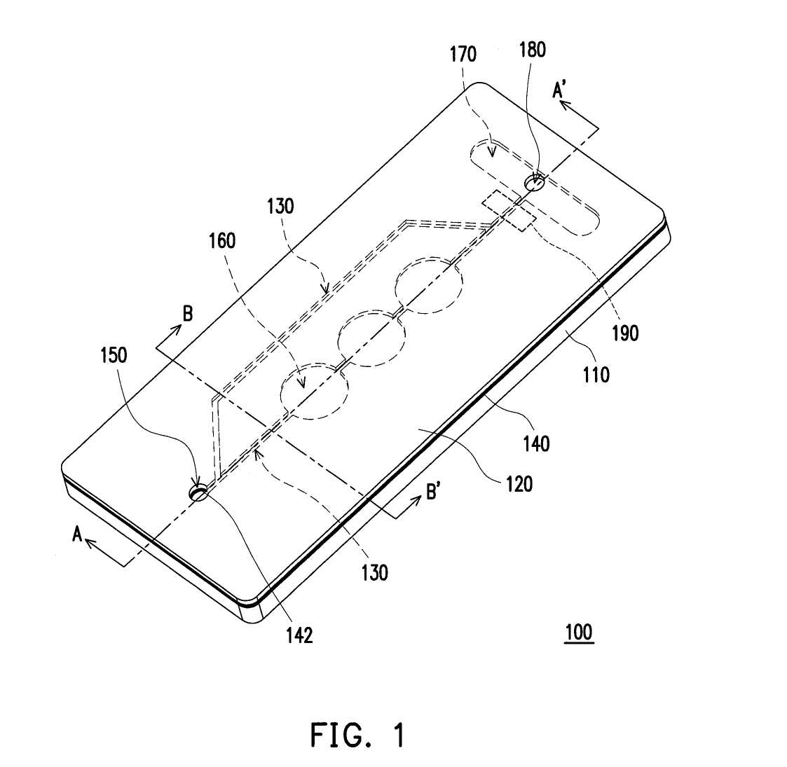

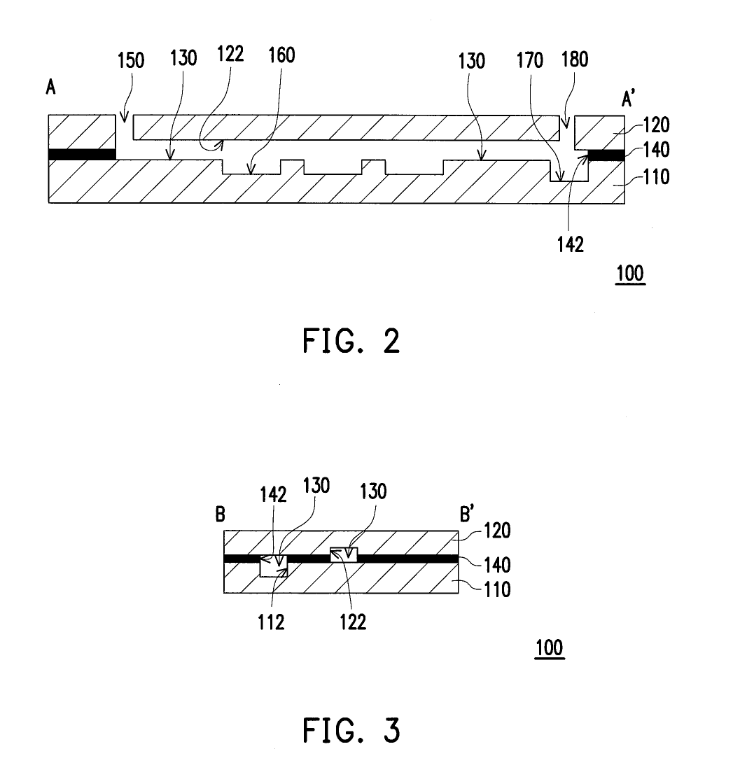

FIG. 1 is a schematic view illustrating a micro-channel module according to an embodiment of the present invention. FIG. 2 is a schematic cross-sectional view illustrating the micro-channel module of FIG. 1 along line A-A′. FIG. 3 is a schematic cross-sectional view illustrating the micro-channel module of FIG. 1 along line B-B′. Referring to FIG. 1 through FIG. 3, in the present embodiment, a micro-channel module 100 includes a lower plate 110, an upper plate 120, and a double-side tape 140. The upper plate 120 is disposed on the lower plate 110. The double-side tape 140 is disposed between the upper plate 120 and the lower plate 110, so as to fix the upper plate 120 and the lower plate 110. In other words, the micro-channel module 100 of the present embodiment includes the lower plate 110 and the upper plate 120, which are laminated by the double-side tape 140. The double-side tape 140 has a plurality of micro-channel patterns 142, so as to define a plurality of micro-channels 130 between the upper plate 120 and the lower plate 110. More specifically, the double-side tape 140 of the present embodiment appears to be in a thin film shape, and an external profile thereof is substantially identical to external profiles of the upper plate 120 and the lower plate 110 which appear to be in panel shapes, wherein portions of the double-side tape 140 are hollowed out to form the micro-channel patterns 142. As such, after the lower plate 110 and the upper plate 120 are laminated and fixed by the double-side tape 140, the micro-channel patterns 142 on the double-side tape 140 may define the micro-channels 130 between the upper plate 120 and the lower plate 110. Namely, space encircled by the lower plate 110, the upper plate 120 and hollowed areas (the micro-channel patterns 142) of the double-side tape 140 may be used as the micro-channels 130. In other words, upper walls and lower walls of the micro-channels 130 may be surfaces of the upper plate 120 and the lower plate 110, and side walls of the micro-channels 130 may be inner side surfaces of the micro-channel patterns 142. As such, the micro-channels 130 are substantially in a sealed state, and a liquid not illustrated is adapted to flow in the micro-channels 130. In addition, when the liquid flows in the micro-channels 130, the liquid is in contact with the upper plate 120, the lower plate 110 and the double-side tape 140 located between the upper plate 120 and the lower plate 110 (e.g., in contact with the inner side surfaces of the micro-channel patterns 142). Thus, according to a material property of the liquid, materials of the lower plate 110, the upper plate 120 and the double-side tape 140 preferably are selected from those which do not react with the adopted liquid, so as to prevent a reaction with the liquid when the liquid flows in the micro-channel 130 to change a biological property of the liquid. However, the present application does not limit the materials of the lower plate 110, the upper plate 120 and the double-side tape 140, and the materials may be adjusted according to requirements.

More specifically, the double-side tape 140 may be a tape without base material or a tape with base material, wherein the tape without base material includes two layers of release papers and an adhesive layer located therebetween. The tape with base material includes a base material, two layers of the adhesive layer on top and bottom, and two layers of the release paper on outermost sides. The present embodiment adopts the tape with base material, and a total thickness thereof without the release papers is approximately 0.1 mm. A method of forming the micro-channel pattern 142 is, for example, by using a punching process, so as to hollow out the double-side tape 140. As compared with the conventional method of forming the micro-channel by using a photolithography or laser process, the micro-channel module of the present embodiment is fabricated in a simplified method and fabricating costs thereof may be reduced.

Besides, in the present embodiment, the micro-channel 130 may be formed by an encirclement of the lower plate 110, the upper plate 120 and the micro-channel pattern 142 on the double-side tape 140. In addition to the above, according to desired depth or sectional area of the micro-channel 130, the micro-channel 130 may also be extended to a portion of the lower plate 110 or the upper plate 120. Specifically speaking, the upper plate 120 of the present embodiment has at least one trench 122, which corresponds to and is connected to one of the micro-channels 130. In other words, one of the micro-channels 130 (e.g., the micro-channel 130 as marked in FIG. 2) of the present embodiment includes the micro-channel pattern 142, the trench 122 located at the upper plate 120 and the lower plate 110, and a depth direction of the micro-channel 130 is to extend toward the upper plate 120. Furthermore, the lower plate 110 of the present embodiment has at least one trench 112, which corresponds to and is connected to one of the micro-channels 130. In other words, one of the micro-channels 130 (e.g., the micro-channel 130 as marked on the left side of FIG. 3) of the present embodiment includes the micro-channel pattern 142, the trench 112 located at the lower plate 110 and the upper plate 120, and the depth direction of the micro-channel 130 is to extend toward the lower plate 110. However, in other embodiments which are not illustrated, the upper plate 120 and the lower plate 110 may also have the trenches 122 and 112, respectively. Besides, the trench 122 of the upper plate 120 and the trench 112 of the lower plate 110 correspond to and connected to one of the micro-channels 130. In other words, the micro-channel 130 includes the micro-channel pattern 142, the trench 112 located at the lower plate 110 and the trench 122 located at the upper plate 120, and the depth directions of the micro-channel 130 extend toward the lower plate 110 and the upper plate 120. Namely, the micro-channel 130 extends to the upper plate 120 and the lower plate 110 at the same time. Thus, it is concluded that the present application does not limit to whether the micro-channel 130 extends to the upper plate 120 or the lower plate 110, and adjustments may be made according to practical requirements. For example, the micro-channel 130 may be composed of only the micro-channel pattern 142, or extend to the upper plate 120 and/or the lower plate 110. Moreover, part of the micro-channels 130 which extend to the upper plate 120 (composed of the micro-channel pattern 142 and the trench 122) may have different depths, while part of the micro-channels 130 which extend to the lower plate 110 (composed of the micro-channel pattern 142 and the trench 112) may also have different depths. When the micro-channels 130 are respectively located at different level heights (e.g., extending respectively to the upper plate 120 or the lower plate 110 or having different depths), the liquid (not illustrated) may flow in the micro-channels 130, or, deposition or separation may occur.

On the other hand, in the present embodiment, the micro-channel module 100 further includes a liquid inlet 150 and a settling recess 160. The liquid inlet 150 passes through the upper plate 120 and is connected to one of the micro-channels 130. In other words, the liquid inlet 150 may connect an exterior with one of the micro-channels 130 located inside the micro-channel module 100. However, in other embodiments, the liquid inlet 150 may also be modified to pass through the lower plate 110. The present application does not limit a location of the liquid inlet 150. Accordingly, the liquid which is not illustrated is adapted to flow into the micro-channels 130 located between the lower plate 110 and the upper plate 120 through the liquid inlet 150. In addition, the settling recess 160 is disposed at the lower plate 110 and located between the upper plate 120 and the lower plate 110. However, in other embodiments, the settling recess 160 may also be modified to be disposed at the lower plate 110 and the upper plate 120 at the same time. The present application does not limit a location of the settling recess 160. The settling recess 160 is connected to portions of the micro-channels 130, such as being connected to two micro-channels 130 as marked in FIG. 2. Accordingly, the liquid (not illustrated) which flows in the micro-channel 130 from the liquid inlet 150 is adapted to flow into the settling recess 160 through one of the micro-channels 130 (e.g. the micro-channel 130 as marked on the left side of FIG. 2), and flow out of the settling recess 160 through another one of the micro-channels 130 (e.g. the micro-channel 130 as marked on the right side of FIG. 2). To be more specific, a bottom of the micro-channel 130 of the present embodiment which corresponds to and is connected to the settling recess 160 is higher than a bottom of the settling recess 160, or a depth of the micro-channel 130 which corresponds to and is connected to the settling recess 160 is less than a depth of the settling recess 160, such that a height drop exists between the settling recess 160 and the micro-channel 130 which corresponds to and is connected to the settling recess 160. Accordingly, after the liquid which is not illustrated flows into the settling recess 160 from one of the micro-channels 130, partial ingredients are separated from the liquid inside the settling recess 160 through deposition. In other words, the partial ingredients of the liquid is deposited at the bottom of the settling recess 160, and since the height drop exists between the settling recess 160 and the micro-channel 130 which corresponds to and is connected to the settling recess 160, the liquid from which the partial ingredients is separated is adapted to flow out of the settling recess 160 through another one of micro-channels 130. In view of the above, the micro-channel module 100 may be configured to allow the partial ingredients to be separated from the liquid, and the partial ingredients separated from the liquid or the remaining liquid from which the partial ingredients are separated may be detected.

For example, in the present embodiment, the micro-channel module 100 may further include a waste liquid recess 170. The waste liquid recess 170 is disposed at the lower plate 110 and located between the upper plate 120 and the lower plate 110. However, in other embodiments, the waste liquid recess 170 may also be modified to be disposed at the lower plate 110 and the upper plate 120 at the same time. The present application does not limit a location of the waste liquid recess 170. The waste liquid recess 170 is connected to one of the micro-channels 130, and the settling recess 160 is located between the liquid inlet 150 and the waste liquid recess 170. Accordingly, after the liquid which is not illustrated flows into the settling recess 160 and the partial ingredients thereof are separated therefrom through deposition, the partial ingredients separated from the liquid are deposited in the settling recess 160, while the liquid after the partial ingredients are separated therefrom is adapted to flow into and be gathered in the waste liquid recess 170 from the settling recess 160 through one of the micro-channels 130. In other words, the used liquid (i.e., from which partial ingredients have been separated) may be gathered by the waste liquid recess 170. In addition, in the present embodiment, the micro-channel module 100 further includes an exhaust outlet 180. The exhaust outlet 180 passes through the upper plate 120 and is connected to one of the micro-channels 130 and the waste liquid recess 170. In other words, the exhaust outlet 180 may connect an exterior with one of the micro-channels 130 located between the lower plate 110 and the upper plate 120. Accordingly, after the liquid flows in the micro-channel 130, air in the micro-channel 130 may flow out of the micro-channels 130 through the exhaust outlet 180.

In the present embodiment, the micro-channel module 100 further includes a measurement area 190 (as marked in FIG. 1). The measurement area 190 is located at the upper plate 120 or the lower plate 110, and is connected to one of the micro-channels 130. In other words, the measurement area 190 is an area which is located between the upper plate 120 and the lower plate 110 and connected to the micro-channels 130. A substantive embodiment of the measurement area 190 may be a recess (not illustrated) disposed at the upper plate 120 or the lower plate 110 and connected with the micro-channels 130, but the present application is not limited thereto. Furthermore, the measurement area 190 of the present embodiment is located between the settling recess 160 and the waste liquid recess 170. As such, a chip which is not illustrated is adapted to be disposed in the measurement area 190, wherein the chip is, for example, a biochip, but the present application does not limit varieties of the chip. Accordingly, after the partial ingredients of the liquid which is not illustrated are separated from the liquid in the settling recess 160 through deposition, the liquid after the partial ingredients are separated therefrom is adapted to flow through the biochip located in the measurement area 190 through one of the micro-channels 130, so that the biochip detects biological properties of the liquid after the partial ingredients are separated therefrom. More specifically, the biochip located in the measurement area 190 may be electrically connected to an inspection system which is not illustrated. When the liquid after the partial ingredients are separated therefrom flows through the biochip, the biochip may detect the liquid so as to generate an electrical signal containing a biological property to the inspection system. In addition, the liquid after the partial ingredients are separated therefrom passes through the measurement area 190 and the biochip, the micro-channel module 100 may gather the used liquid (after being detected by the biochip) from the waste liquid recess 170. Accordingly, when the micro-channel 100 is applied to a disposable inspection component (not illustrated), the used liquid flows into and be gathered in the waste liquid recess 170 through the corresponding micro-channel 130 before the used liquid is discarded, and there is no need to take out the used liquid.

In summarizing the above, in the micro-channel module of the present application, the upper plate and the lower plate are directly laminated and fixed by the double-side tape, and a plurality of micro-channels are defined between the upper plate and the lower plate through the micro-channel patterns on the double-side tape, such that the liquid may flow in the micro-channels. To be more specific, the micro-channels include the upper plate, the lower plate and the micro-channel patterns located on the double-side tape, and parts of the micro-channels may also be extended to portions of the upper plate and/or the lower plate according to requirements, such that the depths thereof are adjusted. Moreover, the micro-channel module may be provided with a liquid inlet, a settling recess, a waste liquid recess, or an exhaust outlet according to requirements, so as to inject the liquid into the micro-channel module, separate partial ingredients therefrom through deposition, or gather the used liquid. A method for forming the micro-channel patterns is, for example, by a punching process, so as to hollow out the double-side tape. As compared with the conventional method of forming the micro-channel by using a photolithography or laser process, the micro-channel module of the present application is fabricated in a simplified method and fabricating costs thereof may be reduced.

Although the present application has been disclosed with reference to the aforesaid embodiments, they are not intended to limit the present application. It will be apparent to those skilled in the art that various modifications and variations can be made to the structure of the disclosed embodiments without departing from the scope or spirit of the present application. In view of the foregoing, it is intended that the disclosure cover modifications and variations of the specification provided they fall within the scope of the following claims and their equivalents.

What is claimed is:

1. A micro-channel module, comprising:
a lower plate;
an upper, disposed on the lower plate; and
a double-side tape, disposed between the upper plate and the lower plate, so as to fix the upper plate and the lower plate, wherein the double-side tape has a plurality of micro-channel patterns, so as to define a plurality of micro-channels between the upper plate and the lower plate, and a liquid is adapted to flow in the micro-channels.

2. The micro-channel module as claimed in claim 1, wherein the upper plate has at least one trench corresponding to and connected to one of the micro-channels.

3. The micro-channel module as claimed in claim 1, wherein the lower plate has at least one trench corresponding to and connected to one of the micro-channels.

4. The micro-channel module as claimed in claim 1, wherein the upper plate and the lower plate respectively has at least one trench, the trench of the upper plate and the trench of the lower plate correspond to and connected to one of the micro-channels.

5. The micro-channel module as claimed in claim 1, further comprising:
a liquid inlet, passing through the upper plate or the lower plate, and connected to one of the micro-channels, the liquid being adapted to flow into the micro-channels through the liquid inlet.

6. The micro-channel module as claimed in claim 1, further comprising:
a settling recess, at least disposed at the upper plate or the lower plate and located between the upper plate and the lower plate, the settling recess connected to portions of the micro-channels, the liquid being adapted to flow into the settling recess through one of the micro-channels.

7. The micro-channel module as claimed in claim 1, further comprising:
a waste liquid recess, at least disposed at the upper plate or the lower plate and located between the upper plate and the lower plate, the waste liquid recess connected to one of the micro-channels, the liquid being adapted to flow into the waste liquid recess through one of the micro-channels.

8. The micro-channel module as claimed in claim 1, further comprising:
an exhaust outlet, passing through the upper plate and connected to one of the micro-channels, air in the micro-channels being adapted to flow out of the micro-channels through the exhaust outlet.

9. The micro-channel module as claimed in claim 1, further comprising:
a measurement area, located at the upper plate or the lower plate and connected to one of the micro-channels, wherein a biochip is adapted to be disposed in the measurement area, and the liquid is adapted to flow through the biochip located in the measurement area through one of the micro-channels, so that the biochip detects a biological property of the liquid.
